(19) United States
(12) Patent Application Publication
(10) Pub. No.: US 2023/0349199 A1
(43) Pub. Date: Nov. 2, 2023

(54) SMART DEVICE FOR AUTHORIZING MERCHANDISE SECURITY KEYS

(71) Applicant: InVue Security Products Inc., Charlotte, NC (US)

(72) Inventors: Steven R Bohon, Charlotte, NC (US); Gary A Taylor, Fort Mill, SC (US); Christopher J Fawcett, Charlotte, NC (US); Jeffrey A Grant, Charlotte, NC (US)

(21) Appl. No.: 18/033,177

(22) PCT Filed: Oct. 21, 2021
(86) PCT No.: PCT/US2021/055987

§ 371 Date: Apr. 21, 2023

Related U.S. Application Data
(60) Provisional application No. 63/104,113, filed on Oct. 22, 2020.

(51) Int. Cl. E05B 73/00; E05B 47/00

(52) U.S. Cl. CPC E05B 73/0017; E05B 47/00; E05B 2047/0095

(57) ABSTRACT

Embodiments of the present invention are directed to a merchandise security devices, keys, systems, and methods for displaying an item of merchandise and protecting the merchandise from theft. A merchandise security system includes a merchandise security key comprising wireless communication circuitry, the merchandise security key configured to operate a merchandise security device. The merchandise security system also includes a smart device comprising wireless communication circuitry, wherein the smart device is configured to communicate with the merchandise security key via respective wireless communication circuitry to determine whether to authorize the merchandise security key to operate the merchandise security device.

### CROSS REFERENCE TO RELATED APPLICATIONS

This application claims the benefits of priority to U.S. Provisional Application No. 63/104,113 filed on Oct. 22, 2020, the entire contents of which are hereby incorporated by reference.

### FIELD OF THE INVENTION

Embodiments of the present invention relate generally to merchandise security keys, devices, systems, and methods.

### BACKGROUND OF THE INVENTION

Some locks are able to operate without a conventional key, such as home security locks using a smartphone to unlock the lock. Other locks may operate with a mechanical or an electronic key, such as for security in retail stores or other commercial settings. Electronic keys are important for several reasons. For example, the keys can be coded to a given user, allowing the business establishment to track his or her use, which avoids the issue of the user using his or her own personal smartphone for privacy reasons. Thus, in lieu of supplying every user with a company phone, an expensive proposition, an electronic key may be used instead. Another advantage is that electronic keys sometimes have the ability to transfer power to the lock to operate the lock. This is not currently possible with a smartphone.

However, the current state of these key systems is that they require some of kind programming or authorization station. Typically, this is a standalone device or a cable attached to a computer system. These authorization devices may have detriments. For instance, authorization devices can be expensive and tend to be located in backroom areas of retail stores, thus requiring employees to go to that area in order to authorize their key. This can be a problem when the employee is not near the backroom and their key needs to be re-authorized. Finally, the keys may have a window of potential theft if an employee were to lose the key.

### BRIEF SUMMARY

Embodiments of the present invention are directed towards a merchandise security system comprising a merchandise security key including wireless communication circuitry. The merchandise security key is configured to operate a merchandise security device. The system further includes a smart device comprising wireless communication circuitry, wherein the smart device is configured to communicate with the merchandise security key via respective wireless communication circuitry to determine whether to authorize the merchandise security key to operate the merchandise security device.

In another embodiment, a system is provided that includes a programmable key comprising wireless communication circuitry, wherein the programmable key is configured to operate a wireless device. The system also includes a smart device comprising wireless communication circuitry, wherein the smart device is configured to communicate with the programmable key via respective wireless communication circuitry to determine whether to authorize the programmable key to operate the wireless device.

In another embodiment, a method includes wirelessly communicating between a merchandise security key and a smart device via respective wireless communication circuitry and determining with the smart device whether to authorize the merchandise security key to operate the merchandise security device. The method further includes operating the merchandise security device with the merchandise security key after the merchandise security key is authorized

### BRIEF DESCRIPTION OF THE DRAWINGS

FIG. 1 illustrates a merchandise security device according to one embodiment of the present invention.

FIG. 2 illustrates a merchandise security device according to one embodiment of the present invention.

FIG. 3 illustrates a merchandise security device according to one embodiment of the present invention.

FIG. 4A illustrates a merchandise security device according to one embodiment of the present invention.

FIG. 4B illustrates the merchandise security device of FIG. 4A displaying a Smartphone.

FIG. 5A illustrates a merchandise security device according to one embodiment of the present invention.

FIG. 5B illustrates the merchandise security device of FIG. 5A in communication with a merchandise security key.

FIG. 6A illustrates a merchandise security device according to one embodiment of the present invention.

FIG. 6B illustrates the merchandise security device of FIG. 5A in communication with a merchandise security key.

FIG. 7 illustrates a merchandise security device in communication with a merchandise security key according to one embodiment of the present invention.

FIG. 8 illustrates a merchandise security key according to one embodiment of the present invention.

FIG. 8A illustrates the merchandise security key of FIG. 8 with a portion of the housing removed.

FIG. 9 illustrates a programming station in communication with a merchandise security key according to one embodiment of the present invention.

FIG. 10 illustrates a merchandise security key in communication with a smart device according to one embodiment of the present invention.

### DETAILED DESCRIPTION OF EMBODIMENTS OF THE INVENTION

Referring now to the accompanying drawing figures wherein like reference numerals denote like elements throughout the various views, one or more embodiments of a merchandise security device, key, system, and method for displaying an item of merchandise and protecting the merchandise from theft are shown. Embodiments of the present invention include a smart device operable for communicating with and/or obtaining information from a merchandise security key, such as an electronic or programmable key. More particularly, the smart device may be configured to obtain information stored on the merchandise security key. An electronic merchandise security key according to embodiments of the present invention is suitable for use with a security display, such as an alarming merchandise display stand or puck, a security fixtures or locks, such as a locking merchandise hook or cabinet or door, or security packaging, such a locking merchandise safer, as described in more detail below. In still other examples, the smart device and key may be configured to communicate with any type of wireless device, whether a security device or not (e.g., IoT devices). Thus, references in this disclosure to merchandise security devices and merchandise security keys should not be considered limiting.

The term “smart device”, as used herein is not meant to be limiting and may be any electronic device suitable for interfacing with a merchandise security key, as described in further detail below. In some embodiments, a smart device 100 is a smartphone (e.g., an iPhone®), a mobile or cellular telephone, a tablet (e.g., an iPad®), or the like. The smart device 100 may include one or more components known to those skilled in the art, such as, for example, a housing, a processor disposed within the housing, a display coupled to the housing, a power source (e.g., a battery) for powering the device, wireless communication circuitry, memory, SIM card, SM card, a near field communication (NFC) tag, and/or camera(s).

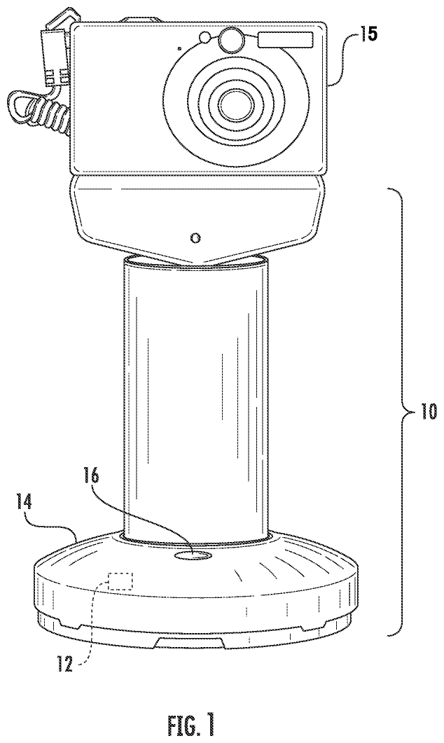

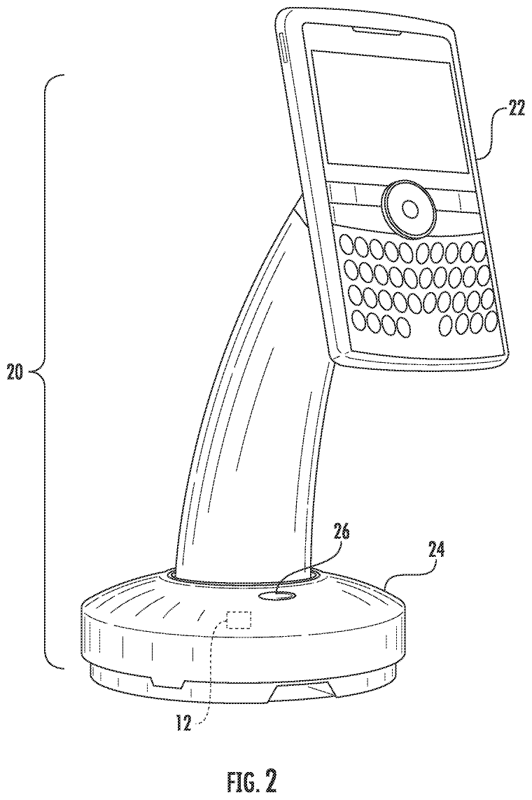

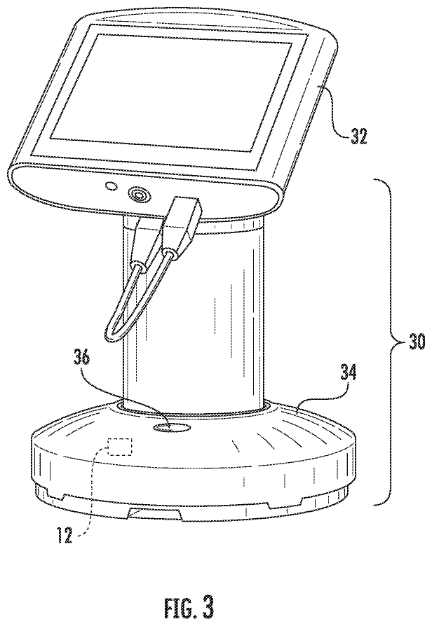

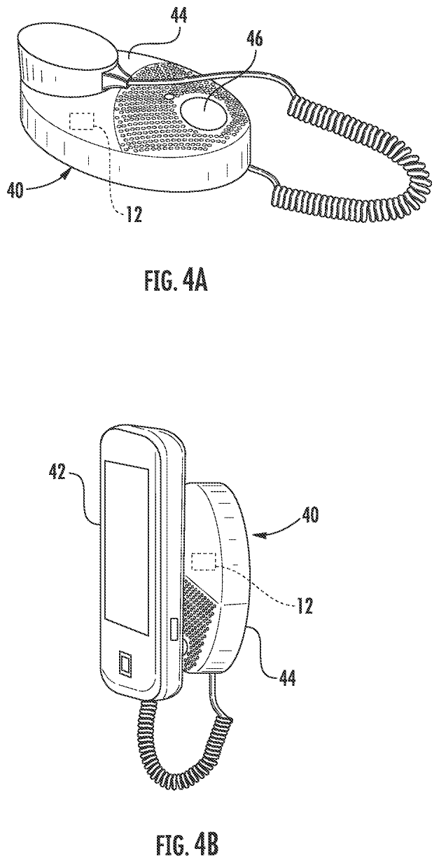

FIGS. 1-3 illustrate a variety of embodiments of merchandise security devices, and more particularly, examples of a security display in the form of an alarming merchandise stand 10, 20, 30 for displaying an electronic item of merchandise and protecting the merchandise from theft. By way of example and not limitation, FIG. 1 shows alarming merchandise display stand 10 configured to display and protect a digital camera 15 from theft. FIG. 2 shows alarming merchandise display stand 20 configured to display and protect a mobile telephone, such as a smartphone 22, from theft. FIG. 3 shows alarming merchandise display stand 30 configured to display and protect an electronic computing device, such as a Global Positioning System (GPS) 32, from theft. FIGS. 4A-4B illustrate an embodiment of a security display in the form of an alarming merchandise display stand 40 for displaying an electronic item of merchandise and protecting the merchandise from theft. By way of example and not limitation, FIG. 4B shows the alarming merchandise display stand 40 configured to display a smartphone 42 on a vertical support surface, such as a wall, pegboard or the like, and to protect the smartphone from theft.

An electronic circuit disposed within base 14, 24, 34, 44 of the corresponding alarming merchandise display stand 10, 20, 30, 40 is operable for arming, disarming, activating and/or deactivating an audio and/or visible alarm provided on the merchandise display stand. As shown and described herein, each of the alarming merchandise stands 10, 20, 30, 40 may have a transfer port 16, 26, 36, 46 disposed, for example, on the base 14, 24, 34, 44 of the merchandise display stand. In some cases, the transfer port 16, 26, 36, 46 may be an interface configured for communication with a merchandise security key. In one example embodiment, the transfer port 16, 26, 36, 46 contains or is otherwise in communication with an inductive coil (not visible) that is operable for cooperating with an inductive coil of a merchandise security key to transfer electrical power from an internal power source of the key to operate a passive electronic lock or a passive electronic locking mechanism on the merchandise stand 10, 20, 30, 40, as will be described in greater detail hereinafter. As used herein, the term “passive” is intended to mean that the lock is not powered, or is not powered by an internal source of power.

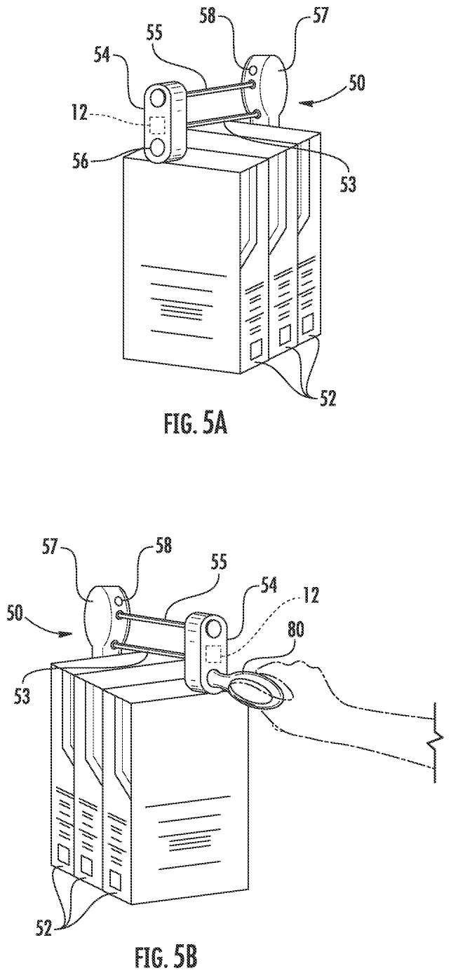

FIGS. 5A-5B illustrate an embodiment of a merchandise security device, and more particularly, a security fixture in the form of a locking merchandise hook 50, for displaying at least one item of merchandise and for protecting the merchandise from theft. By way of example and not limitation, FIGS. 5A-5B show a locking merchandise hook 50 configured to display and protect a plurality of audio accessories 52, namely Bluetooth headsets, from theft. The audio accessories 52 are suspended from a lower rod 53 of the locking merchandise hook, while a locking nose 54 is moveably mounted on an upper rod 55 of the merchandise hook. The locking nose 54 is removably locked to the lower rod 53 and movable along the upper rod 55 away from the lower rod so that one or more of the audio accessories 52 may be removed from the lower rod when the locking nose of the locking merchandise hook 50 is in an unlocked configuration.

An electronic circuit disposed within the locking nose 54 of the locking merchandise hook 50 is operable to unlock a passive electronic lock or a passive electronic locking mechanism configured for locking the locking nose 54 on the lower rod 53 of the merchandise hook. If desired, the electronic circuit of the locking merchandise hook 50 may also be operable for arming, disarming, activating and/or deactivating an audio and/or visible alarm provided on the merchandise hook. As shown and described herein, the locking merchandise hook 50 is further provided with a transfer port 56 disposed, for example, on the locking nose 54 of the merchandise hook. The transfer port 56 contains or is otherwise in communication with an inductive coil (not shown) operable for cooperating with an inductive coil of a merchandise security key 80 to transfer electrical power from an internal power source of the key to operate a passive electronic lock or locking mechanism on the locking nose 54 of the merchandise hook 50, as will be described in greater detail hereinafter. If desired, the merchandise hook 50 may further comprise a locking base 57 for locking the merchandise hook to a vertical support surface, such as a slat wall, pegboard or the like. The locking base 57 may be provided with a transfer port 58 containing or is otherwise in communication with an inductive coil (not shown) for cooperating with the inductive coil of the merchandise security key 80 to transfer electrical power from an internal power source of the key and thereby operate a passive electronic lock or locking mechanism on the locking base of the merchandise hook 50 in a similar manner.

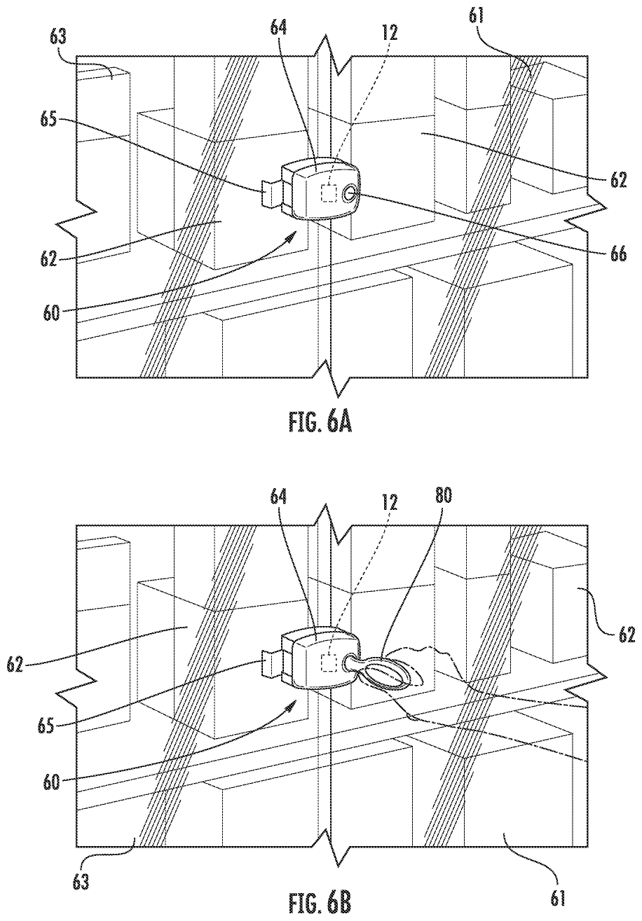

FIGS. 6A-6B illustrate another embodiment of a merchandise security device, and more particularly, a security fixture in the form of a locking merchandise cabinet 60, for displaying an item of merchandise and for protecting the merchandise from theft. By way of example and not limitation, FIGS. 6A-6B show locking merchandise cabinet 60 configured to display and protect a plurality of items of merchandise 62 from theft. The items of merchandise 62 may be disposed within the merchandise cabinet 60 behind a pair opposing, substantially transparent, sliding cabinet doors 61, 63, while a locking base 64 is moveably mounted on one of the cabinet doors. The locking base 64 may be removably locked to a strike plate 65 mounted on the other one of the cabinet doors 61, 63 so that at least one of the opposing, sliding cabinet doors may be moved to permit access to the items of merchandise 62 behind the sliding cabinet doors when the locking merchandise cabinet 60 is in an unlocked configuration.

An electronic circuit disposed within the locking base 64 of the locking merchandise cabinet 60 may be operable to unlock a passive electronic lock or a passive electronic locking mechanism configured for locking the locking base 64 on the strike plate 65 of the other one of the opposing, sliding cabinet doors 61, 63 of the merchandise cabinet. If desired, the electronic circuit of the locking merchandise cabinet 60 may also be operable for arming, disarming, activating and/or deactivating an audio and/or visible alarm provided on the merchandise cabinet. As shown and described herein, the locking merchandise cabinet 60 further has a transfer port 66 disposed, for example, on the locking base 64 of the merchandise cabinet. The transfer port 66 contains or is otherwise in communication with an inductive coil (not shown) operable for cooperating with an inductive coil of a merchandise security key 80 to transfer electrical power from an internal power source of the key to operate a passive electronic lock or locking mechanism on the locking base 64 of the merchandise cabinet 60, as will be described in greater detail hereinafter. In some embodiments, the electronic lock is similar to that disclosed in U.S. Pat. No. 8,860,574, entitled Cabinet Lock for Use With Programmable Electronic Key, filed Sep. 28, 2012, the entire contents of which are incorporated by reference herein.

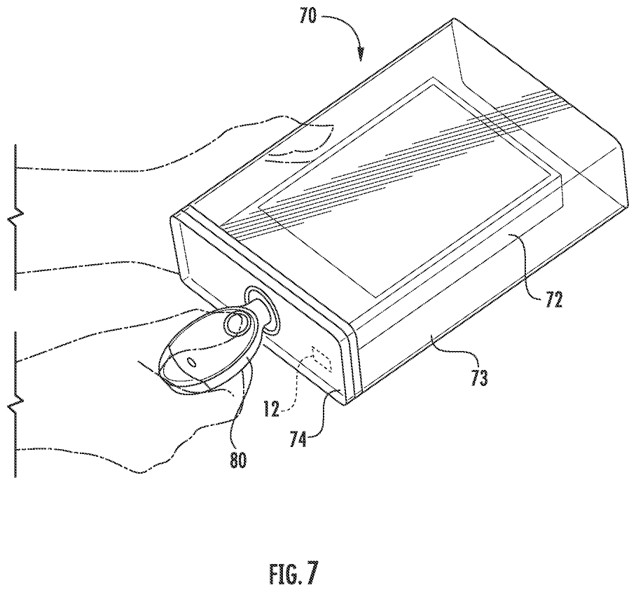

FIG. 7 illustrates an embodiment of a merchandise security device, and more particularly, security packaging in the form of a locking merchandise safer 70, for displaying and protecting an item of merchandise from theft. By way of example and not limitation, FIG. 7 shows locking merchandise safer 70 configured to display and protect an item of merchandise 72 from theft. The item of merchandise 72 is disposed within an interior compartment of a container 73 of the locking merchandise safer 70, while a locking base 74 is moveably mounted on the container. The locking base 74 is removably locked to the container 73 and movable relative to the container away from the interior compartment so that the item of merchandise 72 may be removed from the interior compartment of the container 73 when the locking merchandise safer 70 is in an unlocked configuration.

An electronic circuit disposed within the locking base 74 of the locking merchandise keeper, or safer 70 is operable to unlock the passive electronic lock or locking mechanism for locking the locking base 74 on the container 73 of the merchandise keeper, or safer 70. If desired, the electronic circuit of the locking merchandise safer 70 may also be operable for arming, disarming, activating and/or deactivating an audio and/or visible alarm provided on the merchandise keeper, or safer. As shown and described herein, the locking merchandise safer 70 further has a transfer port 76 disposed, for example, on the underside of the locking base 74 of the merchandise keeper, or safer. The transfer port 76 contains or is otherwise in communication with an inductive coil (not shown) operable for cooperating with an inductive coil of a merchandise security key 80 to transfer electrical power from an internal power source of the key to operate a passive electronic lock or locking mechanism on the locking base 74 of the merchandise safer 70, as will be described in greater detail hereinafter. In some embodiments, the locking merchandise safer 70 is similar to that disclosed in U.S. Patent Publ. No. 2015/0013398, entitled Merchandise Security Devices for Use with an Electronic Key, filed Jul. 10, 2014, the entire contents of which are incorporated by reference herein.

Thus, embodiments of the present invention contemplate employing a variety of types of merchandise security devices, such as the examples disclosed above.

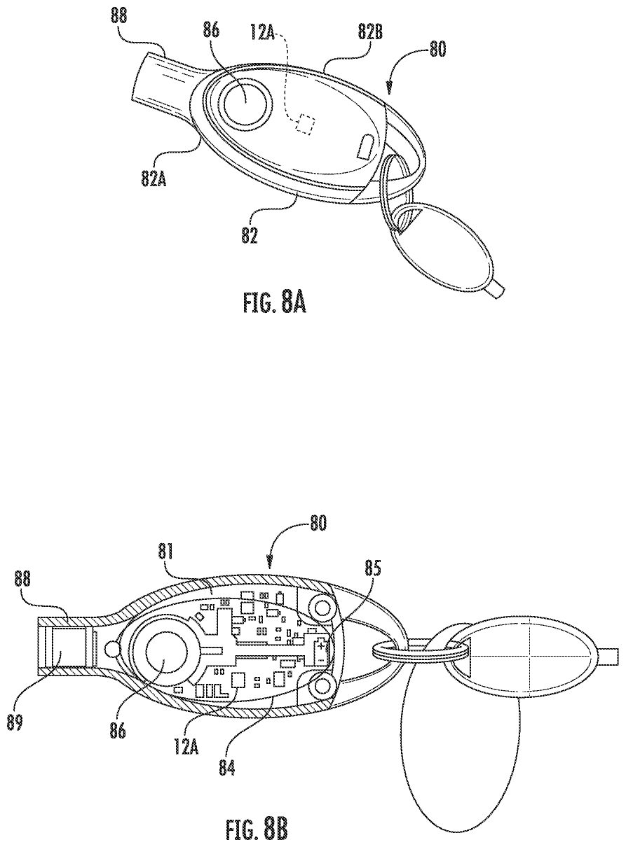

FIGS. 8A-8B show a merchandise security key 80, according to an embodiment of the present invention, for use with a merchandise security device having an electronic alarm circuit and/or a passive electronic lock or a passive electronic locking mechanism. As shown, key 80 comprises a housing 82 defining a generally hollow interior compartment 81 for housing electronic components of the key. By way of example and not limitation, the housing 82 may be formed from a housing bottom portion 82A and a housing top portion 82B that are joined together, for example, by ultrasonic welding, to enclose and protect the electronic components of the key 80.

FIG. 8B shows that an embodiment of the merchandise security key 80 comprises an electronic circuit 84, such as a printed circuit board (PCB), and an internal source of electrical power 85, such as a capacitor or battery, operably coupled with the circuit board to provide electrical power to the electronic components of the key 80. The key 80 further comprises an actuator button 86 positioned over the electronic circuit 84 and accessible from the exterior of housing 82 so as to be operably coupled with the electronic circuit 84 in an actuated position. For example, actuator button 86 may be biased outwardly away from electronic circuit 84 and electrically connect a pair of electrical power leads disposed on the electronic circuit when the actuator button is depressed to provide electrical power from battery 85 to the electronic circuit when the actuator button is depressed. In the embodiments shown and described herein, housing 82 defines a transfer probe 88 at one end and the merchandise security key 80 further comprises an inductive coil 89 disposed within the transfer probe 88 portion of the key for a purpose to be described hereinafter. In some embodiments, the merchandise security key 80 includes wireless communication circuitry configured to communicate with the smart device 100 and/or security device using any of the wireless communication protocols disclosed herein. It is understood that the merchandise security key 80 may take many different forms according to various embodiments, such as those disclosed above. In some cases, the merchandise security key 80 may be any programmable device that is operable to communicate with a smart device 90 and/or merchandise security device, such as, for example, a smart card (e.g., a card including a memory, processor, antenna, etc.). In other instances, the smart device 100 itself may be configured to function has a key and perform the various functionality of the merchandise security device 80 disclosed herein, including for example, transferring power to the security device.

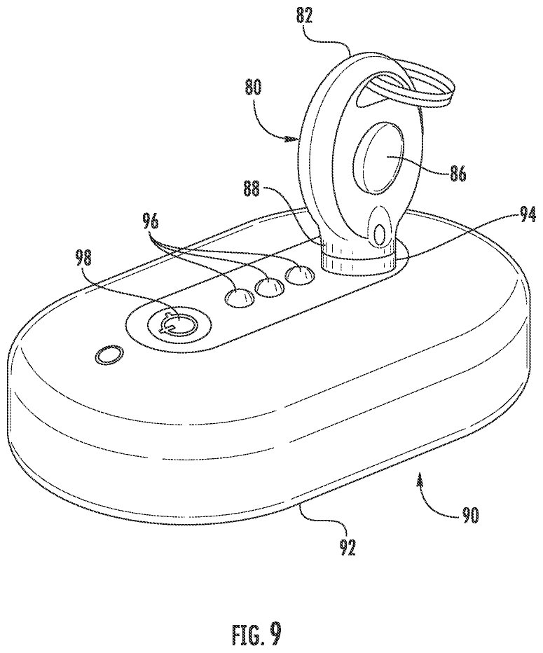

FIG. 9 illustrates a programming or authorization station 90 for use with the merchandise security key 80. The programming station 90 may be a standalone device that is configured to program, authorize, and/or reactivate merchandise security keys. In some cases, the programming station is a specialized device used only for programming the keys 80 and is not a conventional computer. If desired, battery 85 may be a rechargeable battery and programming station 90 may also provide charging capability for the battery of the key 80. As such, station 90 may be a combination programming and/or charging station. Regardless, station 90 comprises a housing 92 that may have at least one transfer port 94 or other communication circuitry. Station 90 may also be provided with one or more status indicators 96 on the exterior of housing 92 for indicating the status of the operation of the station. In one embodiment, the status indicators 96 are a series of different colored light-emitting diodes (LEDs) that illuminate to indicate that station 90 is operating to perform a particular function, such as assigning a security code to the key 80 or charging the key. If desired, station 90 may also comprise a mechanical lock 98 for permitting only an authorized person in possession of a corresponding mechanical key (not shown) to operate the station 90, however, it is understood that other means of authorization could be employed to operate the station such as a pin code, biometric, or the like.

Regardless, station 90 may operate to assign, authorize, or program, the merchandise security key 80 with a security code and/or to communicate data with the key. By way of example and not limitation, the security code may be a unique alphanumeric code that is randomly generated and unknown to any person such that the security code cannot be replicated on any other key 80. In another embodiment, the security code may be a preselected unique alphanumeric code that is assigned to a particular retail store such that all keys 80 programmed by the station 90 will be operable with any merchandise security device at that retail store that is programmed with the same unique alphanumeric security code. Regardless, in one embodiment, the merchandise security key 80 programmed by station 90 with a security code operates to transfer the security code to a merchandise security device having an electronic alarm circuit and a transfer port, such as any of the alarming merchandise display stands 10, 20, 30 shown in FIGS. 1-3. In one embodiment, the security code may be transferred when the transfer probe 88 of the merchandise security key 80 is positioned over or proximate to the transfer port provided on the merchandise security device. In other words, the key 80 is used to program the merchandise security device with the security code. Thereafter, when the transfer probe 88 is positioned over or proximate to the transfer port and actuator button 86 is depressed, merchandise security key 80 determines whether the merchandise security device is programmed with a security code that matches the security code of the key. If the security codes match, the electronic alarm circuit of the merchandise security device is armed, disarmed, activated or deactivated, depending on the current status of the electronic alarm circuit. It is understood that the transfer port of the merchandise security devices and/or programming station may be omitted in cases where the key 80 is able to wirelessly communicate directly with the wireless communication circuitry of the security devices and/or programming station without the need for a transfer port.

An available feature of a merchandise security system and method according to an embodiment of the invention is that the smart device 100 and/or the merchandise security key 80 may include a time-out function. More particularly, the ability of the smart device 100 and/or the merchandise security key 80 to transfer data and/or power to the merchandise security device is deactivated after a predetermined time period. By way of example, the key 80 may be configured to be deactivated after about six to twelve hours (e.g., about eight hours) from the time the key was programmed or last refreshed by the programming station. In this manner, an authorized sales associate typically must program or refresh the key 80 assigned to him or her at the beginning of each work shift using a programming station 90. Furthermore, the smart device 100 may be configured to deactivate the key 80 after a predetermined period of time. Similarly, the smart device 100 may be deactivated after a predetermined period of time such that the smart device would require a password or the smart device and/or electronic key 80 would need to be refreshed or reprogrammed.

As previously mentioned, in one embodiment, the merchandise security key 80 may comprise an inductive coil 89 operable for transferring electrical power from the battery 85 of the key to a merchandise security device. The inductive coil 89 may be disposed within a transfer probe 88 of the key that is configured to be positioned over or proximate to a corresponding transfer port provided on the exterior of the merchandise security device. The transfer port contains a corresponding inductive coil that is likewise operable for transferring the electrical power from the key to the merchandise security device. More specifically, the electronic circuit 84 of the key may cause an electric current to be passed through the inductive coil 89 when the actuator button 86 is depressed. The electric current passing through the inductive coil 89 generates a magnetic field within the inductive coil. When the inductive coil 89 of the key 80 is in close proximity to the corresponding inductive coil of the merchandise security device, the magnetic field induces an electric current through the inductive coil of the merchandise security device. The induced electric current is routed to an electronic circuit disposed within the merchandise security device and provided to operate an electronic lock or electronic locking mechanism.

Of course, other forms of power transfer between the key 80 and/or smart device 100 and the merchandise security device may be contemplated. For instance, passive Near Field Communication (NFC) communication may be employed for facilitating such power transfer from the key 80 and/or the smart device 100 for operating the merchandise security device (e.g., pursuant to the NFC Forum Wireless Charging Specification). Moreover, power transfer can occur when the key 80 and/or the smart device 100 is proximate to the merchandise security device (e.g., but not necessarily in direct contact or close contact thereto (e.g., close contact being less than 1 inch from the security device). The power transfer from the key 80 and/or the smart device 100 may occur upon the occurrence of one or more criteria including user intent, such as for example, pressing a button 86 or actuator on the key or smart device, the user approaching the security device, the user gesturing in a way that shows intent (e.g., reaching the key towards the security device), etc. In some cases, the key 80 and/or the smart device 100 may be configured to learn certain user behaviors showing an intent to control the security device (e.g., via artificial intelligence). In still other examples, the smart device 100 may be configured to activate its camera and/or microphone to determine whether the user intends to operate the security device (e.g., via optical or audio recognition). In some embodiments, other techniques for transferring power to the security device from the key 80 and/or the smart device 100 may be occur using ultrasonic communication. In other alternatives, the security device may employ energy harvesting to perform one or more functions. For instance, the security device may be configured to harvest enough power to transmit a signal to facilitate communication with the key 80 and/or the smart device 100. The harvested power may not provide full power for accessing the security device but may be enough power to transmit a communication signal.

The merchandise security key 80 and the smart device 100 may be configured to communicate with one another using a variety of wireless communication protocols, such as, for example, Bluetooth, Near Field Communication (NFC), Wi-Fi, or LoRa. In one example embodiment, the smart device 100 is provided with NFC functionality operable for communicating with (e.g., to obtain information from) a merchandise security key 80. In other cases, the smart device may be configured to communicate with the merchandise security key 80 via a wired connection. Thus, the following discussion of the use of NFC tags is not intended to be limiting as the merchandise security key 80 and smart device 100 may communicate using any desired wireless communication.

In some example embodiments, key 80 comprises NFC functionality in the form of one or more NFC tags, chips, or stickers, for facilitating NFC with a smart device 100 and/or security device (10, 20, 30, 40, 50, 60, 70). In this regard, a merchandise security key 80 comprising a NFC tag 12A may communicate with the smart device 100 comprising a NFC tag 12A via NFC to transmit data when the key and the smart device are positioned in direct contact with or proximate to one another. Similar communication may occur between the NFC tag of the security device and the NFC tags of the key 80 and/or the smart device. The NFC tags 12, 12A may have an antenna for effectuating NFC with other keys, security devices, and/or smart devices having NFC functionality. Regardless, the NFC tags 12A of the merchandise security key 80 and the smart device 100 may be configured to communicate wirelessly with one another to thereby exchange data and/or authorize certain operations of the merchandise security device, including without limitation, arming, disarming, locking, and/or unlocking a merchandise security device. In some embodiments, the key 80 and smart device 100 may include similar functionality to that disclosed in U.S. Patent Publ. No. 2016/0222699, entitled Smart Device for Use with an Electronic Key, filed on Sep. 9, 2014, the entire disclosure of which is incorporated by reference herein. It is understood that each of the security devices may also have an NFC tag 12 (or other wireless communication capability) for communicating data with the key 80 and/or the smart device 100 in the same or similar manner as the NFC communication between the NFC tags 12A. Moreover, it is understood that the merchandise security key 80 may be configured to store various information or data (e.g., audit data) in memory rather than with an NFC tag 12A and that the smart device 100 may be configured to communicate with the key to obtain the information or data from the key's memory.

The NFC tags 12, 12A may also be configured to recognize one another such that only particular NFC tags are programmed to communicate with one another. For example, the NFC tag 12 associated with the smart device 100 may be configured to read data from the NFC tag 12A of the merchandise security key 80, or vice versa, the NFC tag of the key may be configured to read data from the NFC tag associated with the smart device 100. Likewise, the key 80 may be configured to read data from the NFC tag 12 of the security device. In particular, the NFC tags 12, 12A may be programmed in any suitable manner to include data that allows the key 80, smart device 100, and/or security device to communicate with one another and to recognize one another. In one embodiment, the NFC tag 12A of the key 80 may include a security code or identifier, and the smart device 100 and/or security device may be programmed with the same security code or identifier. In the event that the security code of the smart device 100 matches the security code of the key 80, the smart device is configured to communicate with the key, such as to obtain data and/or to authorize the key. Similar communication may occur between the key 80 and the security device for determining whether the key is authorized to operate the security device. It is understood that the NFC tags 12, 12A may be active or passive and that the term “tag” is meant to be interpreted broadly, as the tag may be a chip, sticker, processor, controller, electronic circuit or the like that includes NFC functionality.

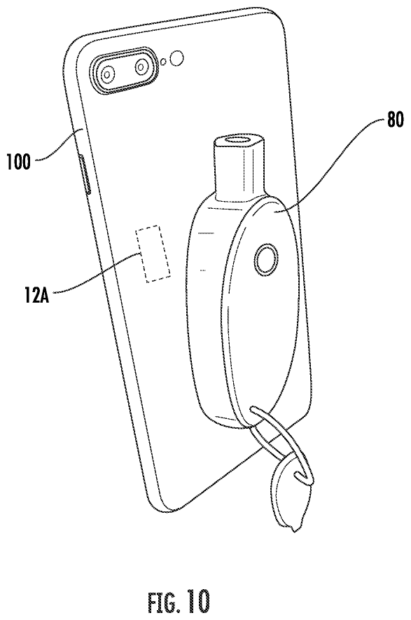

Regardless, the merchandise security key 80 need only be positioned in contact with, proximate, or adjacent to the smart device 100 or security device for communicating therewith (see, e.g., FIG. 10). If desired, the NFC tag 12A of the merchandise security key 80 may be programmed to communicate with the NFC tag 12A of the smart device 100 or the NFC tag 12 of the security device within a particular distance, such as, for example, within about 5 inches or less, or within about 3 inches or less, or within about 1 inch or less. Thus, a user of the merchandise security key 80 may not be required to manually depress the actuator button 86 of the key or otherwise manually activate the key in order to initiate communication with the smart device 100 or security device. In other words, communication may occur automatically when the key 80 and smart device 100 or the key and the security device are within a predetermined distance of one another. In addition, the smart device 100 does not necessarily require an interface, such as a transfer port, for interacting with a feature of the merchandise security key 80, such as transfer probe 88, so that contactless communication between the key and the smart device 100 may occur. In other embodiments, the contactless communication between the key 80 and the smart device 100 may permit the transfer probe 88 and the transfer port to interact in the manner previously described to arm, disarm, activate or deactivate an alarm circuit via Infrared (IR) transmission between the key and the merchandise security device. Alternatively, the NFC between the merchandise security key 80 and the smart device 100 may directly arm, disarm, activate or deactivate an alarm circuit of the merchandise security device. Still further, the NFC between the key 80 and the smart device 100 may permit the key to transfer electrical power to the merchandise security device to operate a passive electronic lock or passive electronic locking mechanism in the manner previously described.

If desired, the inductive coil 89 of the merchandise security key 80 may operate as an NFC antenna for the key. However, an NFC antenna may be located, positioned or disposed anywhere on or within the housing 82 of the key 80.

In one embodiment, the NFC tag 12A of the merchandise security key 80 and/or the NFC tags 12A of the smart devices 100 may be initialized at the time the keys are authorized by a programming station 90. At the time of initialization and installation, the NFC tags 12, 12A are provided with electronic data in the form of relevant information, for example, a retail store identification, a display area or “zone” identification within the retail store, the type of item of merchandise being displayed and protected on or within the merchandise security device, a security code for permitting operation of an alarm circuit and/or an electronic lock or electronic locking mechanism, etc. In some embodiments, the NFC tag 12A of the smart devices 100 may also contain a list of merchandise security keys 80 authorized to operate the alarm circuit and/or the electronic lock or electronic locking mechanism.

In addition, the NFC tag 12A of the smart device 100 may be configured to read information from the NFC tag 12A of the merchandise security key 80 and to store the information obtained from the NFC tag of the key. If desired, the information obtained from the NFC tag 12A of the merchandise security key 80 may then be downloaded from the memory of the smart device 100 to a computing device, such as a personal computer, tablet, smartphone, etc., and used for data extraction purposes, for example, an inventory tracking application or an audit tracking application in a smart retail environment. One example of such a smart retail environment is disclosed in International Application No. PCT/US2020/031850 filed on May 7, 2020 and entitled Merchandise Display Security Systems and Methods, the contents of which are incorporated by reference herein in their entirety.

The information obtained from the NFC tag 12A of the merchandise security key 80 may also be used to audit the activity and/or movement of store personnel, such as sales associates, in the retail store. By way of example and not limitation, each sales associate would be required to present a merchandise security key 80 having NFC functionality (e.g., a NFC tag 12A) to a merchandise security device having NFC functionality (e.g., a NFC tag 12) at a predetermined location and at predetermined times. The memory of the merchandise security key 80 would then record the location of the merchandise security device and the time the key was presented to the merchandise security device to be downloaded to the audit tracking application for the purpose of determining where and when each sales associate “clocked in” and/or “clocked out” in a manner similar to a clock-card. The smart device 100 may then be configured to communicate with the merchandise security key 80 for obtaining the data.

Therefore, in some embodiments, the programming or authorization station 90 may be omitted in the case where the smart device 100 is configured to program, obtain data from, and/or authorize the merchandise security key 80. For example, a user may be able to download a software application to his or her smart device 100 and log into his or her employer's account with personal credentials (e.g., a password or a biometric authentication). The smart device 100 may be further configured to request the user for credentials (e.g., a password or a biometric authentication) when the user wishes to authorize a key. If the user is authorized, the user may then place the merchandise security key 80 in close proximity to the smart device 100, and the data would transfer from the key to the smart device 100 in the same manner as would have been accomplished using the programing station 90. This embodiment may completely eliminate the need for a programming station 90 and all its costs and provide the user with greater flexibility. However, there may be a security concern for hacking the smart device 100, and the key is often the receptacle for the gathered data about interactions with security devices. Typically, this data is provided to the programming station 90 upon return of the key 80 and then delivered to the back-end system for analysis. With the programming station 90 eliminated, some other method of delivering this data may be utilized, such as the key 80 having a wireless communication circuitry (e.g., Wi-Fi or LoRa) to deliver this data directly to the smart device 100 or the back-end system. As a further means of security, the key 80 may utilize additional authorization, such as biometric identification, that is stored locally in the key but is not otherwise communicated to the smart device or the security device. In this way, privacy concerns may be limited since the biometric information may not be transmitted in any way but simply used for authenticating the user of the key 80 (or one or more users authorized to use the key) prior to an attempted operation of the security device.

Another embodiment would also utilize the programming station 90, but allow users to re-authorize or reactivate the merchandise security key 80 using his or her smart device 100, such as after a merchandise security key has been inactivated after a predetermined period of time as described above. This would eliminate the problem of users having to return to a sometimes inconvenient location of the programming station 90, while also maintaining the enhanced security of the physical programming station. In this implementation, the software application on the smart device 100 may only be configured to provide a “re-authorization” command. For example, the smart device 100 and the key 80 may be configured to communicate with another to determine if the smart device is authorized to reactivate the key. In one example, the software application on the smart device 100 may deliver a user ID # to the merchandise security key 80 when the smart device communicates therewith. The merchandise security key 80 would then compare the ID to the last known user ID it had authorized and, upon a match, authorize or re-authorize the key if the key had timed out. This embodiment minimizes the security risk of the smart device 100 as only the user ID is being transmitted, which is useless without a physical key that was originally authorized using that user information from a programming station 90. It also addresses the problem of keys 80 needing to be reauthorized mid-shift in that the user can simply use his or her smart device 100 to re-authorize the merchandise security key 80 without having to return to the programming station 90.

In another embodiment, the merchandise security key 80 may be configured to be automatically deauthorized or inactivated based on a proximity of the key 80 relative to the user's smart device 100. In some cases, the proximity detection between the key 80 and smart device 100 may be carried out using wireless communication (e.g., Bluetooth). In one example, the merchandise security key 80 may be paired to a smart device 100 via Bluetooth. The authorization could then be dynamic or “on the fly” with the smart device 100 providing authorization so long as the Bluetooth connection is valid or otherwise communicating with one another. In this implementation, if the user were to accidentally lose his or her key 80, the key would time out immediately resulting in inactivation of the key, and the retailer would be in no risk of a key being used nefariously.

The foregoing has described one or more embodiments of a merchandise security device, key, system, and method for displaying an item of merchandise and protecting the item of merchandise from theft. Those of ordinary skill in the art, however, will readily understand and appreciate that numerous variations and modifications of the invention may be made without departing from the spirit and intended broad scope of the invention. Accordingly, all such variations and modifications are intended to be encompassed by the appended claims.

1. A merchandise security system comprising:
a merchandise security key comprising wireless communication circuitry, the merchandise security key configured to operate a merchandise security device; and
a smart device comprising wireless communication circuitry;
wherein the smart device is configured to communicate with the merchandise security key via respective wireless communication circuitry to determine whether to authorize the merchandise security key to operate the merchandise security device.

2. The merchandise security system of claim 1, wherein the merchandise security key comprises a housing and a source of electrical power disposed within the housing.

3. The merchandise security system of claim 2, wherein the merchandise security key is operable for transferring electrical power to the merchandise security device from the source of electrical power if the merchandise security key is authorized by the smart device to operate the merchandise security device.

4. The merchandise security system of claim 1, wherein the merchandise security key comprises an Infrared (IR) transceiver for transmitting an IR transmission to the merchandise security device and for receiving an IR transmission from the merchandise security device.

5. The merchandise security system of claim 4, wherein the IR transmission of the merchandise security key comprises a security code.

6. The merchandise security system of claim 1, wherein the wireless communication circuitry of each of the merchandise security key and the smart device comprises NFC communication circuitry.

7. The merchandise security system of claim 6, wherein each of the merchandise security key and the smart device comprises a NFC tag for communicating via NFC.

8. The merchandise security system of claim 7, wherein the NFC tag of the smart device is configured to read information from the NFC tag of the merchandise security key.

9. The merchandise security system of claim 1, further comprising a merchandise security device, wherein the merchandise security key is configured to operate the merchandise security device only after being authorized by the smart device.

10. The merchandise security system of claim 1, further comprising a programming station configured to generate a security code, each of the merchandise security key and the merchandise security device configured to store the security code, and wherein the merchandise security key is configured to operate the merchandise security device only if the security codes match one another.

11. The merchandise security system of claim 1, wherein the merchandise security key is configured to be inactivated after a predetermined period of time, and wherein the smart device is configured to communicate with the merchandise security key to reactivate the merchandise security key.

12. The merchandise security system of claim 1, wherein the merchandise security key is not programmed or authorized using a programming or authorization station.

13. The merchandise security system of claim 1, wherein the smart device is not a programming station or an authorization station.

14. The merchandise security system of claim 1, wherein the merchandise security key is configured to be inactivated based on a proximity of the merchandise security key relative to the smart device.

15. The merchandise security system of claim 1, wherein the smart device is a mobile phone.

16. The merchandise security system of claim 1, wherein the smart device is configured to operate the merchandise security device.

17. The merchandise security system of claim 1, wherein the merchandise security key is a smart card.

18. The merchandise security system of claim 17, wherein the smart card is configured to transfer power to the merchandise security device for operating the merchandise security device.

19. The merchandise security system of claim 1, wherein the merchandise security key is configured to automatically communicate with the smart device when within a predetermined distance of one another.

20. (canceled)

21. A system comprising:
a programmable key comprising wireless communication circuitry, the programmable key configured to operate a wireless device; and
a smart device comprising wireless communication circuitry;
wherein the smart device is configured to communicate with the programmable key via respective wireless communication circuitry to determine whether to authorize the programmable key to operate the wireless device.

22. A method comprising:
wirelessly communicating between a merchandise security key and a smart device via respective wireless communication circuitry;
determining with the smart device whether to authorize the merchandise security key to operate the merchandise security device; and
operating the merchandise security device with the merchandise security key after the merchandise security key is authorized.
